(19) United States
(12) Patent Application Publication
(10) Pub. No.: US 2024/0062126 A1
(43) Pub. Date: Feb. 22, 2024

(54) INFORMATION PROVIDING SYSTEM, SERVER DEVICE, AND INFORMATION PROVIDING METHOD

(71) Applicant: Sumitomo Electric Industries, Ltd., Osaka-shi, Osaka (JP)

(72) Inventors: Takashi YAMAMOTO, Osaka-shi, Osaka (JP); Masanobu OE, Osaka-shi, Osaka (JP)

(73) Assignee: Sumitomo Electric Industries, Ltd., Osaka-shi, Osaka (JP)

(21) Appl. No.: 18/270,870

(22) PCT Filed: Jan. 14, 2021
(86) PCT No.: PCT/JP2021/001057

§ 371 Date: Jul. 5, 2023

(51) Int. Cl. G06Q 10/0631; G06T 3/40; G06Q 50/04; G06V 20/52

(52) U.S. Cl. CPC G06Q 10/06311; G06T 3/40; G06Q 50/04; G06V 20/52

(57) ABSTRACT

The information providing system includes: a working terminal; and an instructing terminal that communicates with the working terminal. The working terminal includes: a working communication device that outputs imaging information including an image of the facility captured with a camera; and a working display that displays working information concerning the work carried out in the facility. The instructing terminal includes: an instructing display that displays the captured image based on the imaging information; an interface that receives instructing information serving to offer an instruction for the work carried out in the facility; and an instructing communication device that outputs the instructing information. The working terminal displays, on the working display, the captured image processed based on the imaging information and the instructing information, as the working information.

### TECHNICAL FIELD

This disclosure relates to an information providing system, a server device, an information providing method, and an information providing program.

### BACKGROUND ART

Japanese Patent Laying-Open No. 2019-125996 (PTL 1) discloses a system for inter-group communication between a plurality of terminals loaded within a network.

### CITATION LIST

### Patent Literature

PTL 1: Japanese Patent Laying-Open No. 2019-125996

### SUMMARY OF INVENTION

An information providing system according to this disclosure is for use in providing information of work carried out in a facility. The information providing system includes: a working terminal; and an instructing terminal that communicates with the working terminal. The working terminal includes: a working communication device that outputs imaging information including an image of the facility captured with a camera; and a working display that displays working information concerning the work carried out in the facility. The instructing terminal includes: an instructing display that displays the captured image based on the imaging information; an interface that receives instructing information serving to offer an instruction for the work carried out in the facility; and an instructing communication device that outputs the instructing information. The working terminal displays, on the working display, the captured image processed based on the imaging information and the instructing information, as the working information.

A server device according to this disclosure is for use in providing information of work carried out in a facility. The server device includes: a processor; and a server communication device that communicates with a working terminal and an instructing terminal. The server communication device obtains, from a working terminal, imaging information including an image of the facility captured with a camera and obtains, from the instructing terminal, instructing information serving to offer an instruction for the work carried out in the facility. The processor processes the captured image based on the imaging information and the instructing information to generate the working information concerning the work carried out in the facility that includes the captured and processed image. The server communication device outputs the working information to the working terminal.

An information providing method according to this disclosure is for use in providing information of work carried out in a facility. The information providing method includes: obtaining, from a working terminal, imaging information including an image of a facility captured with a camera; obtaining, from an instructing terminal, instructing information serving to offer an instruction for the work carried out in the facility; processing the captured image based on the imaging information and the instructing information to generate working information concerning the work carried out in the facility that includes the captured and processed image; and outputting the working information to a working terminal.

An information providing program according to this disclosure is for use in providing information of work carried out in a facility. The information providing program prompts a computer to functionally operate as: a communication unit that obtains, from a working terminal, imaging information including an image of the facility captured with a camera and that obtains, from an instructing terminal, instructing information serving to offer an instruction for the work carried out in the facility; and a computing unit that processes the captured image based on the imaging information and the instructing information to generate working information concerning the work carried out in the facility that includes the captured and processed image.

### BRIEF DESCRIPTION OF DRAWINGS

FIG. 1 is a drawing that illustrates an exemplified configuration of an information providing system according to an embodiment.

FIG. 2 is a drawing that illustrates a process to provide working information using an information providing system according to an embodiment.

FIG. 3 is a drawing that illustrates an exemplified mode of operation of a working terminal according to the embodiment.

FIG. 4 is a drawing that illustrates a holder used by a worker who operates the working terminal according to the embodiment.

FIG. 5 is a block diagram that illustrates a hardware configuration of the information providing system according to the embodiment.

FIG. 6 is a block diagram that illustrates a functional configuration of the information providing system according to the embodiment.

FIG. 7 is a drawing that illustrates a facility management table stored in a server device according to the embodiment.

FIG. 8 is a drawing that illustrates a worker management table stored in a server device according to the embodiment.

FIG. 9 is a drawing that illustrates indication changes on a display screen of the working terminal according to the embodiment.

FIG. 10 is a drawing that illustrates indication changes on the display screen of the working terminal according to the embodiment.

FIG. 11 is a drawing that illustrates indication changes on the display screen of the instructing terminal according to the embodiment.

FIG. 12 is a flow chart that illustrates processing steps carried out in the information providing system according to the embodiment.

### DETAILED DESCRIPTION

[Problem to be Solved by the Present Disclosure]

The system described in PTL 1 is operable to communicate with a plurality of terminals. This system, however, does not consider communication performed between working terminals used by factory workers and an instructing terminal used by an instruction provider in a location away from the workers. There may still be room for improvement on how the workers should be instructed to do their work by the instruction provider using the instructing terminal, demanding the development of an improved system that allows the instruction provider to efficiently support the workers.

This disclosure is directed to providing an information providing system, a server device, an information providing method, and an information providing program that can assist an instruction provider in offering efficient support for workers.

[Advantageous Effect of the Present Disclosure]

According to this disclosure, the information providing system, server device, information providing method, and information providing program may ensure that an instruction provider is able to efficiently support workers.

### Description of Embodiments

(1) An information providing system 1 according to this disclosure is for use in providing information of work carried out in a facility 4. Information providing system 1 includes a working terminal 5 and an instructing terminal 6 that communicates with working terminal 5. Working terminal 5 includes: a communication device 52 that outputs imaging information including an image of a facility 4 captured with a camera 56, and a display 54 that displays working information of work carried out in facility 4. Instructing terminal 6 includes: a display 64 that displays the captured image based on the imaging information; an input interface 65 that receives instructing information serving to offer an instruction for work carried out in facility 4; and a communication device 62 that outputs the instructing information. Working terminal 5 displays, on display 54, the captured image processed based on the imaging information and the instructing information, as the working information.

(2) Information providing system 1 in 1) may further include a server device 3 that communicates with working terminal 5 and instructing terminal 6. Server device 3 may include a processor 31 that generates the working information based on the imaging information and the instructing information, and a communication device 32 that outputs the working information to working terminal 5.

(3) In information providing system 1 in 2), processor 31 may enlarge a part of the captured image included in the imaging information based on the instructing information and include the captured image after being enlarged in the working information.

(4) In information providing system 1 in 2), processor 31 may translate a text included in the instructing information and then include the translated text in the working information.

(5) In information providing system 1 in 2), server device 3 may include a memory 33 that stores reference information to be consulted for work carried out in facility 4. Processor 31 may include, in the working information, the reference information selected based on the instructing information.

(6) In information providing system 1 in 5), communication device 52 may output, to server device 3, identification information used to identify a user of working terminal 5. Processor 31 may include, in the working information, the reference information selected based on the instructing information and the identification information.

(7) In information providing system 1 in 2), communication device 32 may further output the working information to instructing terminal 6. Display 64 may display the working information.

(8) In information providing system 1 in 1), working terminal 5 may include camera 56. Communication device 62 may output, to working terminal 5, remote control information for remote control of camera 56.

(9) Server device 3 according to this disclosure is for use in providing information of work carried out in facility 4. Server device 3 includes processor 31 and communication device 32 that communicates with working terminal 5 and instructing terminal 6. Communication device 32 obtains, from working terminal 5, imaging information including an image of facility 4 captured with camera 56 and obtains, from instructing terminal 6, instructing information serving to offer an instruction for the work carried out in facility 4. Processor 31 processes the captured image based on the imaging information and the instructing information to generate the working information concerning the work carried out in facility 4 that includes the captured and processed image. Communication device 32 outputs the working information to working terminal 5.

(10) An information providing method according to this disclosure is for use in providing information of work carried out in facility 4. The information providing method includes: (S32) obtaining, from working terminal 5, imaging information including an image of facility 4 captured with camera 56; (S34) obtaining, from instructing terminal 6, instructing information serving to offer an instruction for the work carried out in facility 4; (S35) processing the captured image based on the imaging information and the instructing information to generate working information concerning the work carried out in facility 4 that includes the captured and processed image; and (S36) outputting the working information to working terminal 5.

(11) An information providing program 331a according to this disclosure is for use in providing information of work carried out in facility 4. Information providing program 331a prompts a server device (computer) 3 to functionally operate as: a communication unit 320 that obtains, from working terminal 5, imaging information including an image of facility 4 captured with camera 56 and that obtains, from instructing terminal 6, instructing information serving to offer an instruction for the work carried out in facility 4; and a computing unit 310 that processes the captured image based on the imaging information and the instructing information to generate working information concerning the work carried out in facility 4 that includes the captured and processed image.

### Description of Embodiments

Embodiments according to this disclosure are hereinafter described in detail referring to the accompanying drawings. The same or similar components and units in the description below are simply illustrated with the same reference signs, redundant description of which will basically be omitted.

<Configuration of Information Providing System>

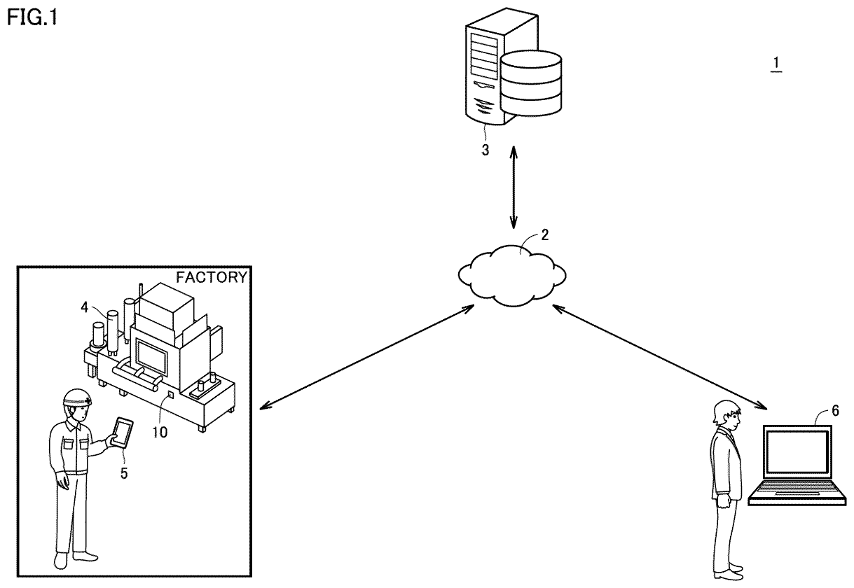

With reference to FIGS. 1 to 6, information providing system 1 according to an embodiment is hereinafter described.

FIG. 1 is a drawing that illustrates an exemplified configuration of information providing system 1 according to this embodiment. As illustrated in FIG. 1, information providing system 1 is equipped with a working terminal 5, an instructing terminal 6, and a server device 3. Working terminal 5 is used by a worker(s) who carries out his/her work using a facility 4 in a factory. Instructing terminal 6 is used by an instruction provider who offers an instruction(s) to the worker(s).

Facility 4 is engaged in the manufacture of, for example, automobile parts and circuit boards and is equipped with machines, tools, and apparatuses used to assemble the parts and circuits into finished products. Examples of facility 4 may include electrical facility, gas facility, plumbing installation, conveyance equipment, air conditioning equipment, and lighting facility.

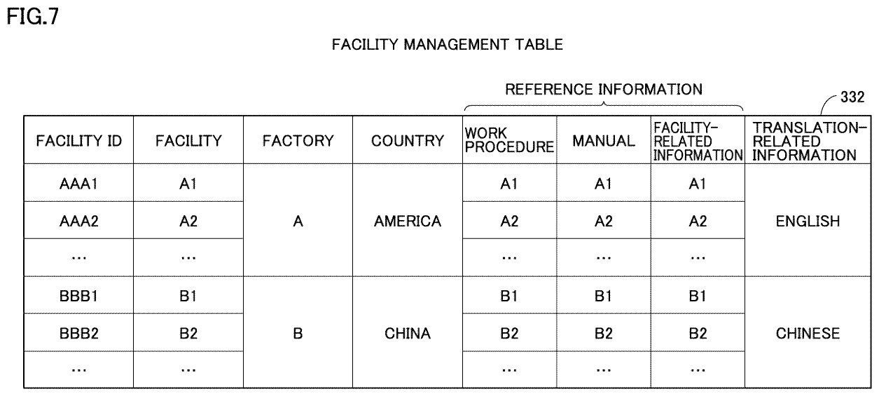

Though not illustrated in the drawings, a factory is installed with a plurality of facilities 4. To each of these facilities 4 is allocated identification information, which is used to identify facility 4. The identification information of facility 4 includes letters and characters, symbols, numbers and/or codes. An example of the identification information of facility 4 used in this embodiment is facility ID (identifier), for example, production serial number of facility 4, as illustrated in FIG. 7 described later. The facility ID is included in a code 10 attached to each facility 4. Examples of code 10 include one-dimensional codes like barcodes and two-dimensional codes like QR codes (registered trademark). Different facility IDs are respectively allocated to facilities 4, and facilities 4 are thus discriminable by server device 3 based on their facility IDs.

Working terminal 5, examples of which may include desktop PC (personal computer), laptop PC, smart phone, PDA (personal digital assistant) and tablet PC, is an information terminal allowed to communicate with server device 3 and instructing terminal 6 through network 2. Working terminal 5 often used by a worker during his/her work may preferably be easy to carry around. Working terminal 5 is allowed to read the facility ID allocated to each facility 4 using a camera 56 described later.

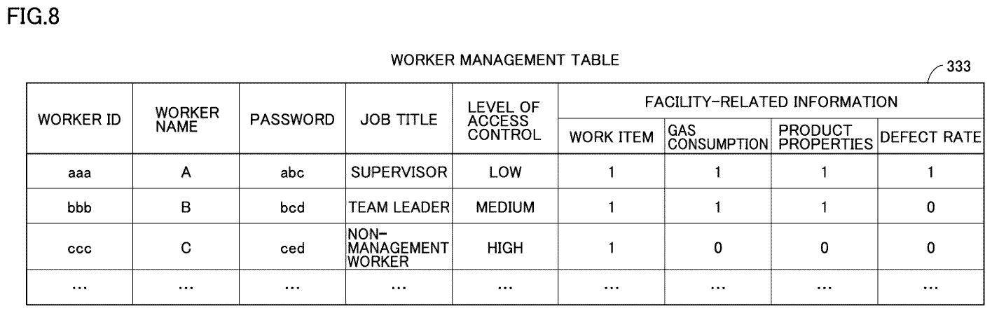

Though not illustrated in the drawings, a plurality of workers, who are each the user of working terminal 5, are engaged in work in a factory. These workers are, for example, chief supervisors, team leaders, and non-management workers, who are allowed to use facility 4 in the factory. To these workers are allocated unique pieces of identification information, which are used to identify them. The worker's identification information includes letters and characters, symbols, numbers and/or codes. An example of the worker's identification information used in this embodiment is worker ID set by a worker him/herself, as illustrated in FIG. 8 described later.

Instructing terminal 6, examples of which may include desktop PC (personal computer), laptop PC, smart phone, PDA (personal digital assistant) and tablet PC, is an information terminal allowed to communicate with server device 3 and working terminal 5 through network 2. The instruction provider may input, to instructing terminal 6, information of a work-related instruction(s) for a worker in facility 4 to be advised of (hereinafter, may be referred to as “instructing information”).

Server device 3, examples of which may include desktop PC (personal computer), laptop PC, smart phone, PDA (personal digital assistant) and tablet PC, is an information terminal allowed to communicate with working terminal 5 and instructing terminal 6 through network 2. Server device 3 provides working terminal 5 with information of work carried out in facility 4 (hereinafter, may be referred to as “working information”) based on the instructing information obtained from instructing terminal 6.

The working information includes, as reference information that can be consulted for work carried out in facility 4, work procedures in facility 4, manuals including an instruction handbook of facility 4, and facility-related information of facility 4. The working information further includes a translation result of a text(s) included in the instructing information.

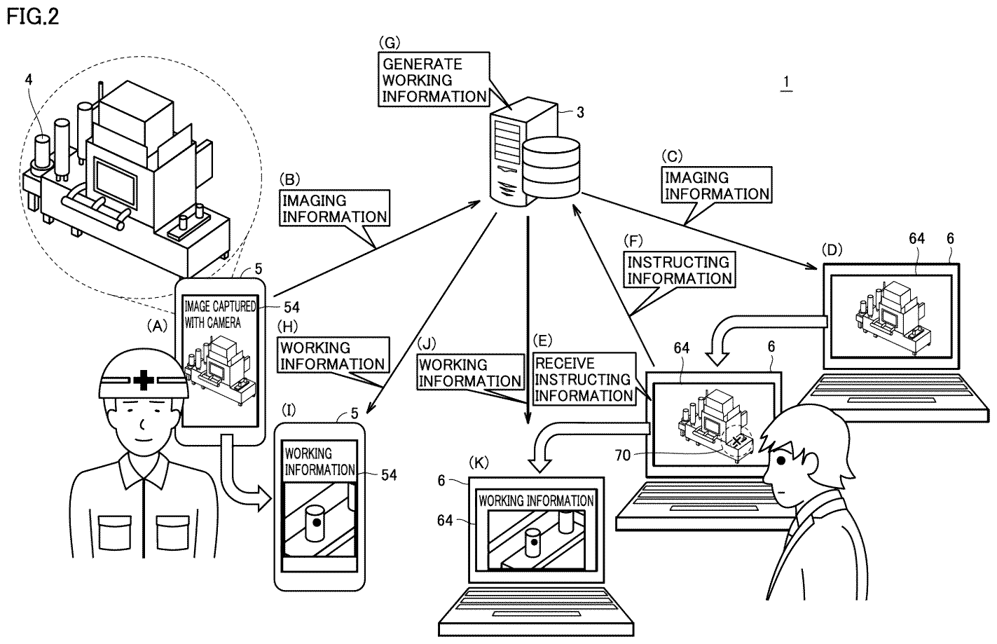

FIG. 2 is a drawing that illustrates a process to provide the working information using information providing system 1 according to this embodiment. This embodiment describes an example in which an instruction provider in a domestic site or factory provides an instruction(s) for a worker engaged in work using facility 4 installed in a factory overseas. In this example, instructing terminal 6 is used in a domestic location, working terminal 5 is used is a location overseas, and server device 3 is installed and used in a different location apart from working terminal 5 and of instructing terminal 6. Server device 3 may be installed in the same location as working terminal 5 or instructing terminal 6 or may serve as a cloud computer in a different location apart from working terminal 5 and instructing terminal 6.

As illustrated in FIG. 2, a worker, who requests an instruction from the instruction provider concerning his/her work carried out in facility 4, captures an image of the whole facility 4 using camera 56 of working terminal 5. Working terminal 5 transmits imaging information including the captured image to server device 3 through network 2 (see (B) in the drawing).

Server device 3 obtains the imaging information from working terminal 5 and transmits the obtained imaging information to instructing terminal 6 through network 2 (see (C) in the drawing) Instructing terminal 6 displays the captured image of facility 4 on display 64 based on the imaging information obtained from server device 3 (see (D) in the drawing).

The instruction provider checks the captured image presented on display 64 of instructing terminal 6 and inputs the instructing information to advise the instruction provider of an instruction(s). In the example of FIG. 2, the instruction provider specifies a worker's working position 70 in the whole facility 4 indicated on the captured image. Instructing terminal 6 receives the instructing information inputted by the instruction provider (see (E) in the drawing). Instructing terminal 6 transmits the received instructing information to server device 3 through network 2 (see (F) in the drawing).

Server device 3 obtains the instructing information from instructing terminal 6 and generates the working information of work carried out in facility 4 based on the instructing information obtained from instructing terminal 6 and the imaging information obtained from working terminal 5 (see (G) in the drawing). To be specific, server device 3 processes the captured image included in the imaging information based on the imaging information and the instructing information, thus generating the working information. In the example of FIG. 2, server device 3 identifies the position specified by the instruction provider based on the instructing information and then enlarges the specified position, thus generating an image that can help the worker to do his/her work.

Server device 3 transmits the generated working information to working terminal 5 through network 2 (see (H) in the drawing). Working terminal 5 presents the processed image on display 54 based on the working information obtained from server device 3 (see (I) in the drawing).

Server device 3 further transmits the generated working information to instructing terminal 6 through network 2 (see (J) in the drawing). Instructing terminal 6 presents the processed image on display 64 based on the working information obtained from server device 3 (see (K) in the drawing).

As described above, the worker outputs, from working terminal 5 to server device 3, the imaging information including the captured image of facility 4. The captured image is then processed based on the instructing information inputted by the instruction provider using instructing terminal 6, which allows the worker to obtain the working information including the processed image. The captured image of facility 4, instead of being processed by the instruction provider him/herself, is automatically processible by server device 3. Then, the instruction provider may successfully provide the worker with the automatically processed, captured image by simply inputting, to instructing terminal 6, the instructing information containing work-related matters for the worker to be advised of. Information providing system 1 may thus allow the instruction provider to efficiently support the worker.

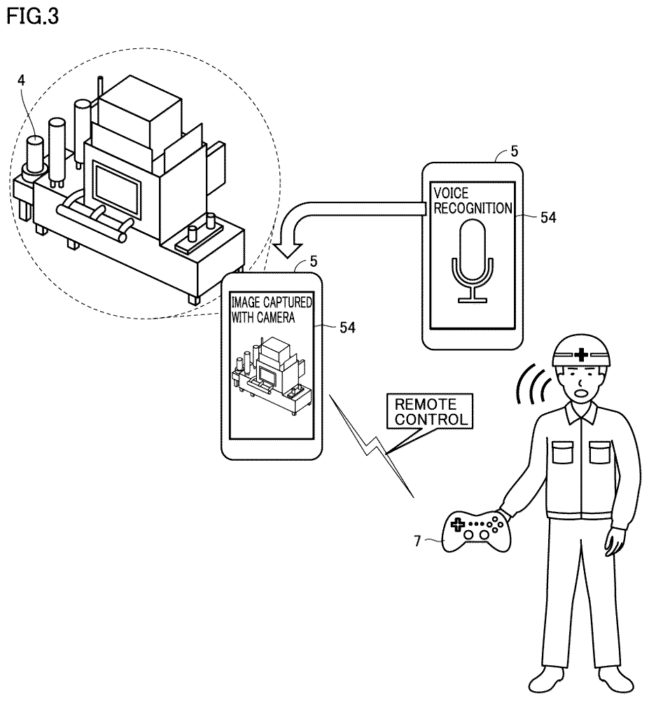

FIG. 3 is a drawing that illustrates an exemplified mode of operation of working terminal 5 according to this embodiment. The worker is regularly working using facility 4 in the factory and is thus often busy with his/her work. The worker may occasionally need to wear gloves during his/her work. The worker, therefore, may be sometimes unable to directly access and operate working terminal 5.

To this end, information providing system 1 according to this embodiment enables two different manners of operating working terminal 5, operation through direct contact of a worker with working terminal 5 using his/her hand, and operation without any physical contact of a worker with working terminal 5.

Specifically, information providing system 1 is equipped with a remote controller 7, as illustrated in FIG. 3. The worker is allowed to remotely control working terminal 5 by handling and manipulating remote controller 7. Remote controller 7 has physical switches, which allow a worker to manipulate this remote controller when he/she is wearing a globe. The physical switches may include, for example, buttons, dials, and joystick that can be directly handled with a worker's glove-worn hand. Remote controller 7 is allowed to perform near field communication with working terminal 5 through Bluetooth (registered trademark) or Wi-Fi. For instance, the worker may manipulate remote controller 7 with his glove-worn hand and activates camera 56 of working terminal 5 to capture an image(s) of facility 4.

The worker, instead of using remote controller 7, may remotely control working terminal 5 using his/her voice through a microphone 57 described later. For example, the worker may use his speech during his/her work and activate camera 56 of working terminal 5 to capture an image(s) of facility 4.

The worker is allowed to request an instruction from the instruction provider by thus manipulating working terminal 5 using remote controller 7 or through voice recognition without any physical contact with working terminal 5. This may improve user-friendliness for the worker during his/her work.

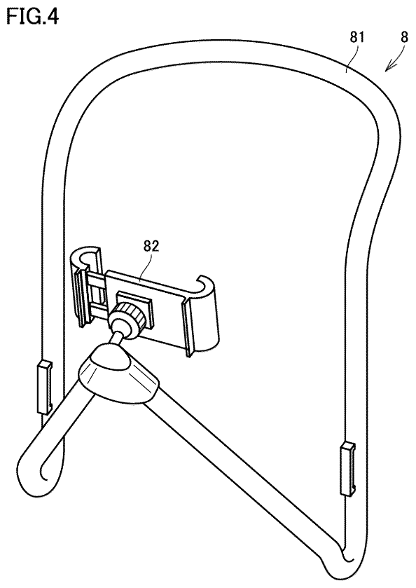

FIG. 4 is a drawing that illustrates a holder 8 used by the worker who operates working terminal 5 according to this embodiment. The worker may immovably secure remote controller 7 or working terminal 5 using holder 8, as illustrated in FIG. 4.

Holder 8 has a frame 81 and a fixture 82 attached to frame 81. Remote controller 7 or working terminal 5 is fixable to frame 81 with fixture 82. Frame 81 may have a shape that allows the worker to wear holder 8 around his/her neck.

The worker, when operating working terminal 5 using remote controller 7, may wear holder 8 around his/her neck, with remote controller 7 being secured to holder 8. The worker, when requesting an instruction from the instruction provider, may remove remote controller 7 from holder 8 to manipulate remote controller 7 or may manipulate remote controller 7 without removing remote controller 7 from holder 8, thus operating working terminal 5.

The worker, when operation working terminal 5 through voice recognition, may wear holder 8 around his/her neck, with working terminal 5 being secured to holder 8. The worker, when requesting an instruction from the instruction provider, may directly input his/her voice to working terminal 5 secured to holder 8, thereby operating working terminal 5.

The worker may not necessarily touch, with his/her hand, remote controller 7 or working terminal 5 thus fixed to holder 8, which improves user-friendliness during his/her work.

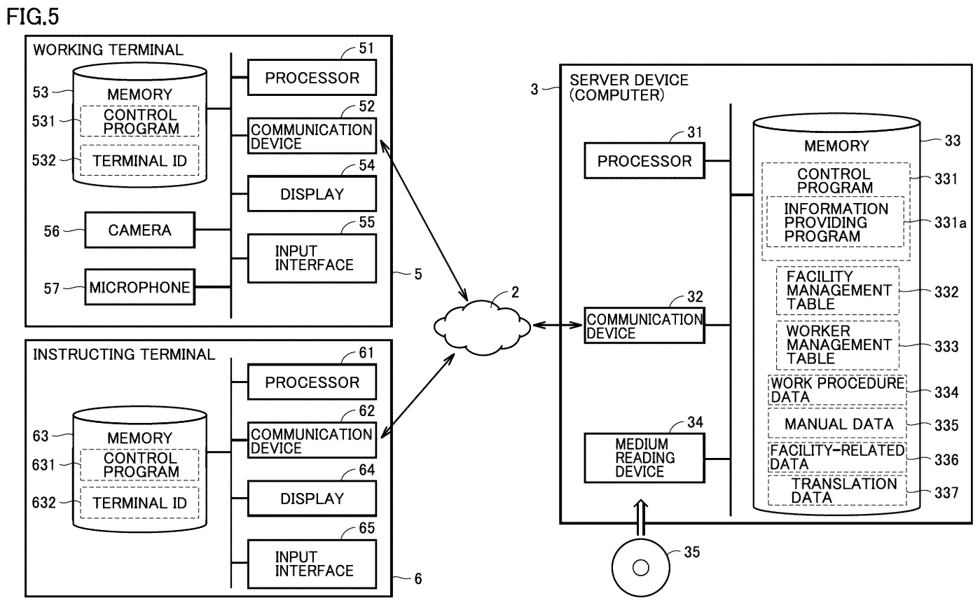

FIG. 5 is a block diagram that illustrates a hardware configuration of information providing system 1 according to this embodiment. As illustrated in FIG. 5, server device 3 is equipped with a processor 31, a communication device 32, a memory 33, and a medium reading device 34.

Processor 31 is a processing device in charge of running a program(s)(for example, control program 331 described later) to carry out processes related to server device 3. Processor 31 may include, for example, at least one of CPU (central processing unit), FPGA (field programmable gate array) and GPU (graphics processing unit). Processor 31 may include a processing circuitry.

Communication device 32 builds communication with working terminal 5 and instructing terminal 6 through network 2 to allow data (information) to be transmitted and received to and from working terminal 5 and instructing terminal 6.

Memory 33 includes a volatile memory, for example, DRAM (dynamic random access memory) and/or SRAM (static random access memory), or may include a non-volatile memory, for example, ROM (read only memory), SSD (solid state drive) and/or HDD (hard disk drive). Memory 33 stores a control program 331, a facility management table 332, a worker management table 333, work procedure data 334, manual data 335, facility-related data 336, and translation data 337.

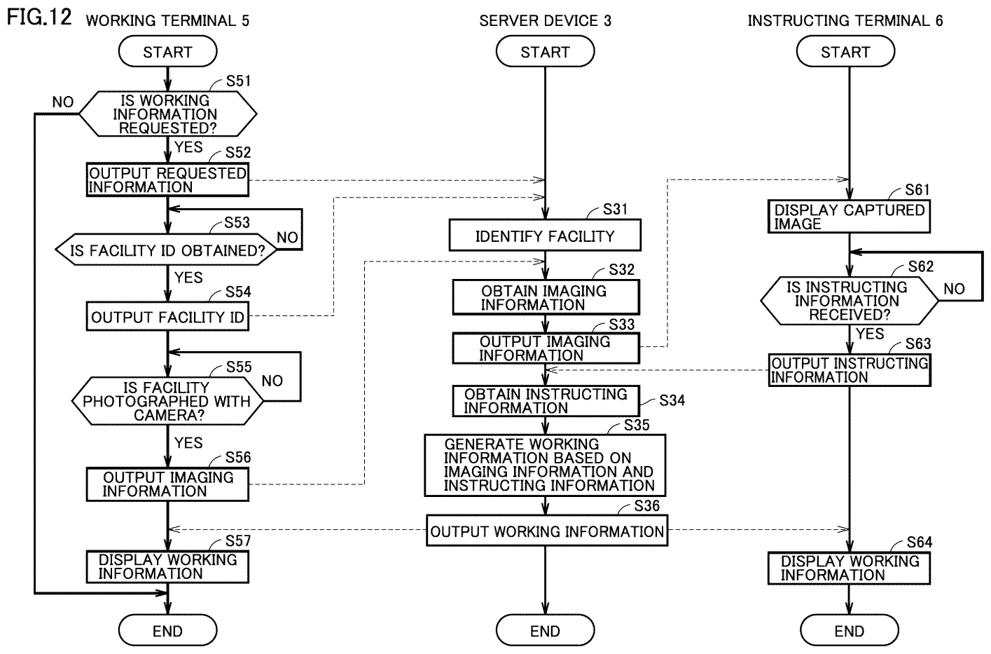

Control program 331 is a program for control of components and units in server device 3, inclusive of an information providing program 331a. Information providing program 331a is a program run to provide a worker with the working information of his/her work in facility 4 in response to the worker's request transmitted from working terminal 5. Processor 31 runs information providing program 331a to carry out the processing steps of FIG. 12 described later. Facility management table 332 contains information for management of facility 4. Worker management table 333 contains information for management of workers. Work procedure data 334 contains information of work procedures in facility 4. Manual data 335 contains information of manuals of facility 4. Facility-related data 336 contains facility-related information. Translation data 337 contains information for translation of a text(s) included in the instructing information inputted to instructing terminal 6.

Medium reading device 34 receives a recording medium 35 in which programs and data are recordable and reads the programs and data from recording medium 35. Examples of recording medium 35 may include CD (compact disk), SD card (secure digital card) and USB memory (universal serial bus memory). In this embodiment, medium reading device 34 reads control program 331 (information providing program 331a) stored in recording medium 35 and stores the read control program 331 (information providing program 331a) in memory 33.

Working terminal 5 is equipped with a processor 51, a communication device 52, a memory 53, a display 54, an input interface 55, a camera 56, and a microphone 57.

Processor 51 is a processing device in charge of running programs (for example, control program 531 described later) to carry out processes related to working terminal Processor 51 may include, for example, at least one of CPU, FPGA and GPU. Processor 51 may include a processing circuitry.

Communication device 52 builds communication with server device 3 and instructing terminal 6 through network 2 to allow data (information) to be transmitted and received to and from server device 3 and instructing terminal 6.

Memory 53 includes a volatile memory, for example, DRAM and/or SRAM or may include a non-volatile memory, for example, ROM, SSD and/or HDD. Memory 53 stores a terminal ID 532 and a control program 531.

Control program 531 is a program for control of components and units of working terminal 5. Terminal ID 532 is information used to identify working terminal 5 and includes the product serial number or IP address (Internet protocol address) of working terminal 5. The “identification information”, an example of which used in this embodiment is the worker ID, may be a terminal ID 532.

Input interface 55 is an interface that receives data inputs to working terminal 5. For instance, the worker may input his/her worker ID and password through input interface 55 or may input information for requesting an instruction from the instruction provider.

Instructing terminal 6 is equipped with a processor 61, a communication device 62, a memory 63, a display 64, and an input interface 65.

Processor 61 is a processing device in charge of running programs (for example, control program 631 described later) to carry out processes related to instructing terminal 6. Processor 61 includes at least one of, for example, CPU, FPGA and GPU. Processor 61 may include a processing circuitry.

Communication device 62 builds communication with working terminal 5 and server device 3 through network 2 to allow data (information) to be transmitted and received to and from working terminal 5 and server device 3.

Memory 63 includes a volatile memory, for example, DRAM and/or SRAM or may include a non-volatile memory, for example, ROM, SSD and/or HDD. Memory 63 stores a control program 631 and a terminal ID 632.

Control program 631 is a program for control of components and units of instructing terminal 6. Terminal ID 632 is information used to identify instructing terminal 6 and includes the product serial number or IP address of instructing terminal 6.

Input interface 65 is an interface that receives data inputs to instructing terminal 6. For instance, the worker may input his/her worker ID and password through input interface 65 or may input instructing information to request an instruction(s) from the instruction provider.

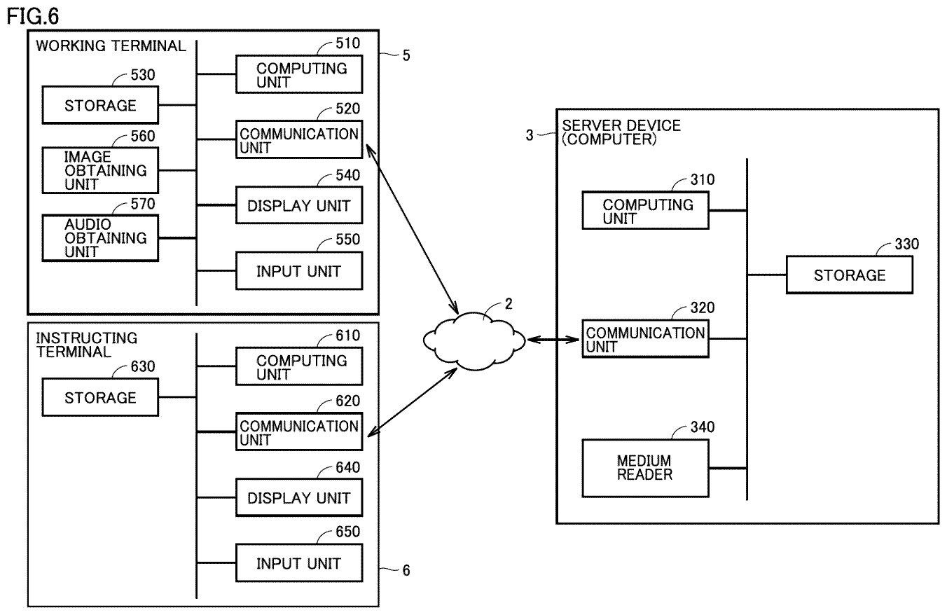

FIG. 6 is a block diagram that illustrates a functional configuration of information providing system 1 according to this embodiment. As illustrated in FIG. 6, principal functional elements of server device 3 include a computing unit 310, a communication unit 320, a storage 330, and a medium reader 340.

Computing unit 310 is a functional element of processor 31, which executes various processes related to server device 3.

Communication unit 320 is a functional element of communication device 32, which allows data (information) to be transmitted and received to and from working terminal 5 and instructing terminal 6 through network 2.

Storage 330 is a functional element of memory 33, and stores the following pieces of information, for example; information on management of facility 4, information used for management of workers, information on manuals of facility 4, facility-related information, and information used for translation of a text(s) included in the instructing information.

Medium reader 340 is a functional element of medium reading device 34. Medium reader 340 reads the programs and data stored in recording medium 35 and stores the read programs and data in storage 330.

Principal functional elements of working terminal 5 include a computing unit 510, a communication unit 520, a storage 530, a display unit 540, an input unit 550, an image obtaining unit 560, and an audio obtaining unit 570.

Computing unit 510 is a functional element of processor 51, which is in charge of executing various processes related to working terminal 5.

Communication unit 520 is a functional element of communication device 52, which allows data (information) to be transmitted and received to and from instructing terminal 6 and server device 3 through network 2.

Storage 530 is a functional element of memory 53, and stores various pieces of information concerning working terminal 5, for example, terminal ID 532.

Display unit 540 is a functional element of display 54, which displays thereon images to broadcast various pieces of information including the working information.

Input unit 550 is a functional element of input interface 55, which receives data inputs to working terminal 5.

Image obtaining unit 560 is a functional element of camera 56, which is manipulated by a worker to capture an image(s) of a target object(s) to obtain the captured image.

Audio obtaining unit 570 is a functional element of microphone 57, which obtains sound and/or voice generated and inputted by a worker as audio data.

Principal functional elements of instructing terminal 6 include a computing unit 610, a communication unit 620, a storage 630, a display unit 640, and an input unit 650.

Computing unit 610 is a functional element of processor 61, which is in charge of executing various processes related to instructing terminal 6.

Communication unit 620 is a functional element of communication device 62, which allows data (information) to be transmitted and received to and from working terminal 5 and server device 3 through network 2.

Storage 630 is a functional element of memory 63, and stores various pieces of information concerning instructing terminal 6, for example, terminal ID 632.

Display unit 640 is a functional element of display 64, which broadcasts various pieces of working information through indication of images.

Input unit 650 is a functional element of input interface 65, which receives data inputs to instructing terminal 6.

<Exemplified Facility Management Table>

With reference to FIG. 7, facility management table 332 stored in server device 3 is hereinafter described. FIG. 7 is a drawing that illustrates facility management table 332 stored in server device 3 according to this embodiment. The facility IDs are each allocated to a respective one of facilities 4 in the factories, and pieces of information of facilities 4 with these facility IDs are storable in facility management table 332, as illustrated in FIG. 7.

In facility management table 332, the following pieces of information concerning facility 4 corresponding to each facility ID, i.e., information used to identify each factory and country installed with a respective one(s) of facilities 4, reference information, and translation-related information are stored. The reference information can be consulted for work carried out in facility 4, which includes work procedure in facility 4, manuals of facility 4, and facility-related information. The translation-related information contains information used to identify a target language(s) of translation of a text(s) included in the instructing information.

For example, information of “facility A1” in “factory A” is stored in facility management table 332 as information of facility 4 with facility ID “AAA1”. In facility management table 332, the following pieces of information on facility A1; information used to identify “America”; country installed with the “facility A1, “work procedure A1”; work procedure in facility A1. “manual A1”; manual of facility A1, “facility-related information A1; information on facility 4, and “English”; target language of translation, are stored.

In regard to the other facilities 4 in factories A and B, information of the facility IDs and facilities 4 with the facility IDs are stored likewise in facility management table 332.

Server device 3, by consulting facility management table 332, is allowed to identify facility 4 with each facility ID obtained from working terminal 5 and is also allowed to identify information related to facility 4. In response to the information of facility 4 being identified, server device 3 extracts, based on the identified information, at least one of the following pieces of data, translation data 337, facility-related data 336, manual data 335 and work procedure data 334 stored in memory 33. Then, server device 3 generates the working information using the extracted piece(s) of data.

<Exemplified Worker Management Table>

With reference to FIG. 8, worker management table 333 stored in server device 3 is hereinafter described. FIG. 8 is a drawing that illustrates worker management table 333 stored in server device 3 according to this embodiment. In worker management table 333, information of workers corresponding to worker IDs which have been allocated to them is stored, as illustrated in FIG. 8.

In worker management table 333, workers' names, passwords and job titles registered in advance in server device 3 by workers themselves are stored, as worker-related information. In the worker management table, access authorities for the facility-related information are defined depending on different types of users (workers) of working terminal 5. Server device 3 extracts, based on the worker ID, a particular piece(s) of facility-related information defined as accessible in worker management table 333 from pieces of different types of facility-related information stored in memory 33. Specifically, server device 3 sets different levels of access control suited to job titles of the registered workers in worker management table 333. The level of access control refers to information on whether a worker can be provided with (whether he/she is granted an access to) the facility-related information depending on the degrees of importance and confidentiality of the requested facility-related information Information of “1” is stored in worker management table 333 for any piece of facility-related information defined as accessible, while information of “0” is stored in this worker management table for any piece of facility-related information defined as inaccessible. The levels of access control include “low” indicating a user most likely to be granted an access to the facility-related information, “high” indicating a user most unlikely to be granted an access to the facility-related information, and “medium” indicating a user between the high and low levels.

The facility-related information contains information of work items to be done by a worker(s) using facility 4, gas consumption in facility 4, properties of products manufactured using facility 4 (parts and components, finished products), and defect rates of products manufactured using facility 4. The work items may include, for example, the rotation number of a roller(s) in facility 4, presence/absence of cracking in facility 4, and air pressure in facility 4. The gas consumption may include, for example, gas consumption per day and gas consumption in total. The product properties may include, for example, voltage, electric current, spring's strength, and thermal radiation rate. The defect rate may include, for example, the count of defects, cumulative count of defects and cumulative ratio for each of different types of defects (including cracking, chipping, heat control error, elasticity control error).

For a worker (chief supervisor) who is subject to the low level of access control, server device 3 is allowed to provide this worker with the work items, gas consumption, product properties, and defect rates. A chief supervisor, who is responsible for knowing details and specifics of facility 4 in the factory, including defect rates, may be a worker allowed to extensively access substantially all types of facility-related information.

For a worker (team leader) who is subject to the medium level of access control, server device 3 is allowed to provide this worker with the work items, gas consumption, and product properties, while prohibiting this worker from accessing the defect rates. A team leader, who may be not as knowledgeable as a chief supervisor, still needs to have a certain amount of knowledge of facility 4 in the factory. The team leader, therefore, may be a worker allowed to access certain pieces of facility-related information including the product properties.

For a worker (non-management worker) who is subject to the high level of access control, server device 3 is allowed to provide this worker with the work items, while prohibiting this worker from accessing the gas consumption, product properties and defect rates. A non-management worker, who only needs to grasp work-related matters of facility 4 in the factory, is a worker only allowed to access the facility-related information of work items alone due to confidentiality required of the defect rates and product properties.

<Example of Providing Working Information>

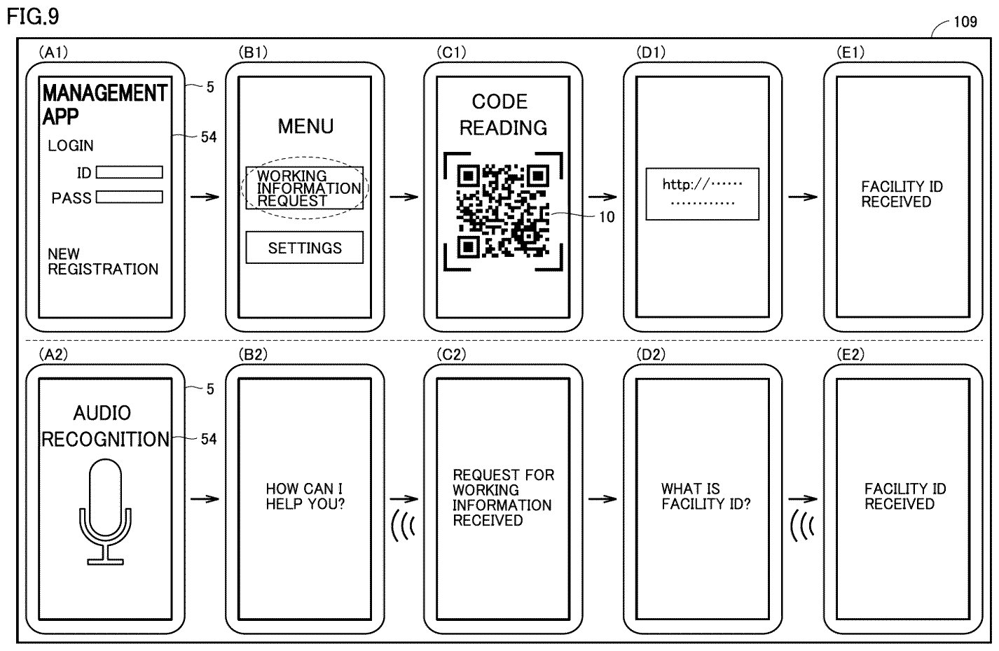

With reference to FIGS. 9 to 11, an example of information providing system 1 providing a worker with the working information is hereinafter described. FIG. 9 is a drawing that illustrates indication changes 109 on display 54 of working terminal 5 according to this embodiment.

First, an example is given and described below, in which a worker operates working terminal 5 through physical contact using his/her hand or remotely controls working terminal 5 using remote controller 7.

An application program for requesting the working information (hereinafter, may be referred to as “app”) has been downloaded beforehand into working terminal 5. When the worker activates the app on working terminal 5, working terminal 5 displays a login screen, as illustrated in FIG. 9 (A1). The login screen includes an entry field for worker ID input, and an entry field for password input. When the worker inputs his/her worker ID and password, working terminal 5 transmits the worker ID and password to server device 3.

When server device 3 authenticates the worker based on the received worker ID and password, working terminal 5 displays a menu screen, as illustrated in FIG. 9 (B1). The menu screen includes an icon for request of working information and an icon for input of settings.

When the worker clicks the icon for request of working information, working terminal 5 displays a code-reader screen to read code 10, as illustrated in FIG. 9 (C1).

When the worker focuses the frame of this code-reader screen on code 10 attached to facility 4, working terminal 5 detects this code 10 using camera 56. Working terminal 5, in response to the detection of code 10, displays an indication of URL (uniform resource locator) to allow the worker to access server device 3, as illustrated in FIG. 9 (D1).

When the worker clicks the URL indication, working terminal 5 displays a message-containing image, notifying the worker that the facility ID has been received, as illustrated in FIG. 9 (E1).

Next, an example is given and described below, in which a worker manipulates and operates working terminal 5 using his/her voice through microphone 57.

When the worker speaks to microphone 57, as illustrated in FIG. 9 (A2), working terminal 5 displays a message-containing image, inquiring of the worker on requirements, as illustrated in FIG. 9 (B2).

When the worker verbally requests the working information through microphone 57, working terminal 5 displays a message-containing image, notifying the worker that his/her request for the working information has been received, as illustrated in FIG. 9 (C2).

As illustrated in FIG. 9 (D2), working terminal 5 displays a message-containing image, requesting the worker to input the facility 1D. When the worker verbally inputs the facility ID through microphone 57, working terminal 5 displays a message-containing image, notifying the worker of that the facility ID has been received, as illustrated in FIG. 9 (E2).

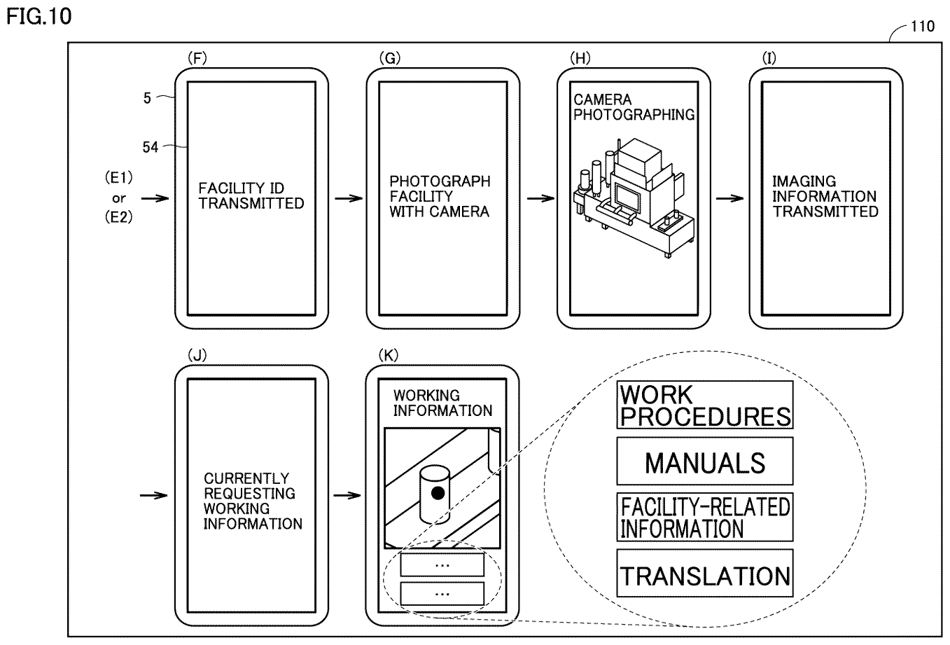

FIG. 10 is a drawing that illustrates indication changes 110 on display 54 of working terminal 5 according to this embodiment.

Following FIGS. 9 (E1) and 9 (E2), working terminal 5 displays a message-containing image, notifying the worker that the received facility ID has been transmitted, as illustrated in FIG. 10 (F).

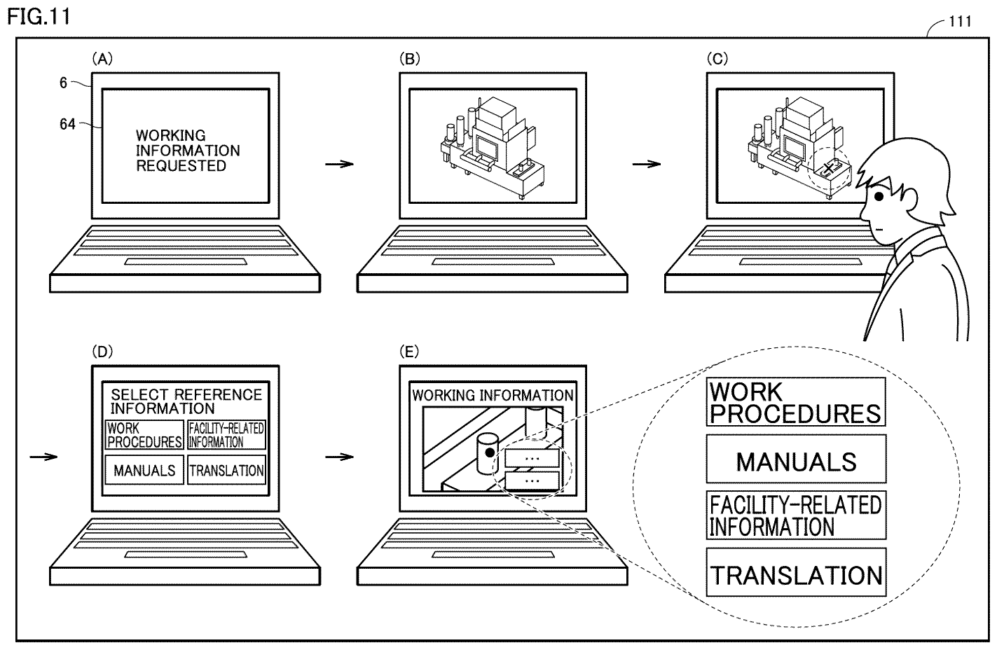

Working terminal 5 displays a message-containing image, requesting the worker to photograph facility 4 with camera 56, as illustrated in FIG. 10 (G). The worker photographs the whole facility 4 using camera 56, and working terminal 5 obtains the captured image of facility 4, as illustrated in FIG. 10 (H). Working terminal 5 transmits imaging information including the captured image to server device 3 and displays a message-containing image, notifying the worker that the imaging information has been transmitted, as illustrated in FIG. 10 (I). After the imaging information is transmitted by working terminal 5 to server device 3, the request for working information is transmitted to and displayed on instructing terminal 6 through server device 3, as illustrated in FIG. 11 (A) described later.

Working terminal 5 displays a message containing image, notifying the worker that the working information is being requested, as illustrated in FIG. 10(J).

Working terminal 5, after being on standby for a while, obtains the working information from server device 3 and then displays the obtained working information, as illustrated in FIG. 10 (K).

For example, working terminal 5 obtains, as the working information, an enlarged image of a part of facility 4 specified by the instruction provider and then displays the enlarged image. The worker, by simply checking the enlarged image presented on display 54, is allowed to easily identify any part of facility 4 as the target site of his/her work.

Working terminal 5 obtains the work procedure in facility 4, manuals of facility 4, facility-related information, and translation result of a text(s) included in the instructing information and then displays an icon that allows these obtained pieces of information to be accessed and viewed. The worker, by manipulating the icon presented on display 54, is allowed to access and view at least one of the work procedure, manuals, facility related information, and translation result. The facility-related information presented on display 54 includes a certain piece(s) of information alone that has been extracted depending on the level of access control set for a worker's job tide, as illustrated in FIG. 8.

FIG. 11 is a drawing that illustrates indication changes 111 on display 64 of instructing terminal 6 according to this embodiment.

When the working information is requested by working terminal 5, instructing terminal 6 displays a message-containing image, notifying a worker that the working information has been requested, as illustrated in FIG. 11 (A). Instructing terminal 6 presents a captured image of the whole facility 4 based on the imaging information obtained from server device 3, as illustrated in FIG. 11 (B).

The instruction provider specifies the worker's working position in the whole facility 4 indicated on the captured image, as illustrated in FIG. 11 (C).

In response to the working position being specified by the instruction provider, instructing terminal 6 displays a screen on which the reference information for working terminal 5 is selectable, as illustrated in FIG. 11 (D). When the instruction provider selects one of the work procedure, manuals, facility-related information and translation, the selected piece of reference information is added to the working information. Thus, the selected piece of reference information is offered to the worker as the working information, as illustrated in FIG. 10 (K).

Instructing terminal 6, after being on standby for a while, obtains the working information from server device 3 and then displays the obtained working information, as illustrated in FIG. 11 (E).

<Processing Steps of Information Providing System>

With reference to FIG. 12, steps of a process carried out in information providing system 1 are hereinafter described. FIG. 12 is a flow chart that illustrates processing steps carried out in information providing system 1 according to this embodiment. The processing steps illustrated in FIG. 12 (hereinafter, may be abbreviated to “S”) are feasible by having the following processors run the respective control programs; processor 51 (computing unit 510) of working terminal 5 runs control program 531, processor 61 (computing unit 610) of instructing terminal 6 runs control program 631, and processor 31 (computing unit 310) of server device 3 runs control program 331 (information providing program 331a).

As illustrated in FIG. 12, working terminal 5, following the login authentication, determines whether the working information has been requested based on the worker's operation performed as in the sequence illustrated in FIG. 9 (S51). When the earlier step determines that the working information has not been requested (NO in S51), working terminal 5 ends this process.

When the earlier step determines that the working information has been requested (YES in S51), working terminal 5 outputs request information to server device 3 to request the working information (S52). Working terminal 5 determines whether the facility ID has been obtained (S53). When the earlier step determines that the facility ID has not been obtained (NO in S53), working terminal 5 repeats the processing step of S53. When the earlier step determines that the facility ID has been obtained (YES in S53), working terminal 5 outputs the facility ID to server device 3 (S54).

Server device 3 identifies, based on the facility ID transmitted from working terminal 5, facility 4 corresponding to this facility ID by consulting the facility management table of FIG. 7 (S31).

After the output of the facility ID, working terminal 5 determines whether facility 4 has been photographed with camera 56 (S55). When the earlier step determines that facility 4 has not been photographed with camera 56 (NO in S55), working terminal 5 repeats the processing step of S55. When the earlier step determines that facility 4 has been photographed with camera 56 (YES in S55), working terminal 5 outputs the imaging information including the obtained image to server device 3 (S56).

Server device 3 obtains the imaging information from working terminal 5 (S32) and then outputs the obtained imaging information to instructing terminal 6 (S33).

Instructing terminal 6 displays, on display 64, the captured image included in the obtained imaging information (S61). Instructing terminal 6 determines whether the instructing information has been received (S62). When the earlier step determines that the instructing information has not been received (NO in S62), instructing terminal 6 repeats the processing step of S62. When the earlier step determines that the instructing information has been received (YES in S62), instructing terminal 6 outputs the instructing information to server device 3 (S63).

Server device 3 obtains the instructing information from instructing terminal 6 (S34). Then, server device 3 generates the working information based on the instructing information obtained from instructing terminal 6 and the imaging information obtained from working terminal 5 (S35). For instance, server device 3, to generate the working information, may obtain an enlarged image of a part of facility 4 in the captured image specified by the instruction provider or may add the reference information selected by the instruction provider to the enlarged image.

Server device 3 outputs the generated working information to working terminal 5 and instructing terminal 6 (S36), and then ends this process.

Working terminal 5 displays, on display 54, the working information obtained from server device 3 (S57), and then ends this process.

Instructing terminal 6 displays, on display 64, the working information obtained from server device 3 (S64), and then ends this process.

In information providing system 1, server device 3 processes the captured image of facility 4 based on the imaging information of facility 4 obtained with camera 56 of working terminal 5 and the instructing information inputted by instructing terminal 6. Then, the working information containing the processed image is offered to working terminal 5 and instructing terminal 6. Information providing system 1 may thus allow the instruction provider to efficiently support the worker.

<Remote Control of Working Terminal's Camera Using Instructing Terminal>

Instructing terminal 6 is equipped to remotely control the camera of working terminal 5. To be specific, instructing terminal 6 outputs, from communication device 62, remote control information for remote control of the camera in working terminal 5 in response to the instruction provider's operation input through input interface 65. The remote control information outputted from communication device 62 is then transmitted to working terminal 5. Optionally, the remote control information may be transmitted to working terminal 5 through server device 3 or may be transmitted to working terminal 5 without the intervention of server device 3. In response to receipt of the remote control information from instructing terminal 6, processor 51 of working terminal 5 controls camera 56 based on the received remote control information.

For example, the instruction provider inputs the instructing information while checking the captured image of facility 4 presented on display 64. At the time, the instruction provider may want to further check facility 4 through a different angle(s) or may want to enlarge and closely check the image of facility 4. The instruction provider may accordingly add an input(s) through input interface 65 for remote control of camera 56. Processor 61 of instructing terminal 6 generates the remote control information based on the input(s) received through input interface 65 and then transmits this remote control information to working terminal 5 using communication device 62. Processor 51 of working terminal 5 controls camera 56 based on the remote control information obtained by communication device 52 to capture an enlarged image(s) and/or a differently angled image(s).

In information providing system 1, instructing terminal 6 is allowed to remotely control camera 56 of working terminal 5 based on the remote control information generated as instructed by the instruction provider. Information providing system 1 may thus allow the instruction provider to efficiently support the worker.

<Operational Effects>

In information providing system 1, working terminal 5 outputs the imaging information containing the captured image of facility 4 obtained with camera 56. Instructing terminal 6 presents the captured image on display 64 based on the imaging information, receives the instructing information that provides an instruction for work in facility 4 through input interface 65, and then outputs the received instructing information. Working terminal 5 presents, on display 54, the working information of work in facility 4 including the captured image which has been processed based on the imaging information and the instructing information. Information providing system 1 may thus allow the instruction provider to efficiently support the worker.

In information providing system 1, server device 3 generates the working information based on the imaging information and the instructing information, and then outputs the generated working information to working terminal 5. Thus, information providing system 1 may successfully provide working terminal 5 with the working information using server device 3 which is allowed to communicate with working terminal 5 and instructing terminal 6.

In information providing system 1, processor 31 of server device 3 enlarges a part of the captured image included in the imaging information obtained from working terminal 5 based on the instructing information obtained from instructing terminal 6, and includes the captured image after being enlarged in the working information. Information providing system 1 is thus allowed to provide working terminal 5 with the captured image already enlarged based on the instructing information from instructing terminal 6, without bothering the instruction provider with such image enlargement. This system may greatly help the instruction provider and successfully allow him/her to offer efficient support for workers.

In information providing system 1, processor 31 of server device 3 translates a text(s) included in the instructing information and includes the translated text(s) in the working information. Information providing system 1 is thus allowed to provide working terminal 5 with the translation of a text(s) included in the instructing information from instructing terminal 6, without bothering the instruction provider with such text translation. This system may greatly help the instruction provider and successfully allow him/her to offer efficient support for workers.

In information providing system 1, processor 31 of server device 3 includes, in the working information, the reference information selected based on the instructing information. Information providing system 1 is thus allowed to provide working terminal 5 with the reference information selected from the facility-related information, manuals, and work procedure stored in memory 33 of server device 3 based on the instructing information from instructing terminal 6, without bothering the instruction provider with preparation of the reference information. This system may greatly help the instruction provider and successfully allow him/her to offer efficient support for workers.

In information providing system 1, processor 31 of server device 3 selects the reference information based on the instructing information and the worker ID used to identify a worker; user of working terminal 5, and then includes the selected reference information in the working information. Taking a worker (chief supervisor) subject to the low level of access control, for instance, as illustrated in FIG. 8, server device 3 extracts, as the reference information (facility-related information), the work items, gas consumption, product properties, and defect rates, providing working terminal 5 with all of these pieces of data. Taking a worker (team leader) subject to the medium level of access control, for instance, server device 3 extracts, as the reference information (facility-related information), the work items, gas consumption, and product properties, providing working terminal 5 with these pieces of data. Server device 3, on the other hand, does not extract the defect rates or allow working terminal 5 to access this piece of data. Taking a worker (non-management worker) subject to the low level of access control, for instance, server device 3 extracts the work items alone as the reference information (facility-related information) and provides working terminal 5 with this extracted piece of data. Server device 3, on the other hand, does not extract gas consumption, product properties or defect rates or allow working terminal 5 to access these pieces of data. Information providing system 1 is thus allowed to provide working terminal 5 with the working information suited to each worker depending on his/her level of access control, without requiring the instruction provider to extract such reference information. This system may greatly help the instruction provider and successfully allow him/her to offer efficient support for workers.

In information providing system 1, server device 3 outputs the generated working information to instructing terminal 6. Instructing terminal 6 presents the working information on display 64. Information providing system 1 is thus allowed to provide not only working terminal 5 but also instructing terminal 6 with the generated working information. This system may allow the instruction provider to check the working information like the workers do, thus successfully offering efficient support for workers.

In information providing system 1, instructing terminal 6 outputs, to working terminal 5, the remote control information for remote control of camera 56 of working terminal 5. Information providing system 1, by thus having the instruction provider remotely control camera 56 of working terminal 5 using instructing terminal 6, may successfully allow the instruction provider to offer efficient support for workers.

### Modified Example

In the earlier embodiment, server device 3, to generate the working information, processes the captured image included in the imaging information obtained from working terminal 5 based on the instructing information from instructing terminal 6. Server device 3 adds the reference information to generate the working information, for example, the enlarged image, translation, and facility-related information. Server device 3 may perform other processed as well. Processor 31 of server device 3 may selectively perform any one of the following processes that can assist the instruction provider in providing an instruction(s) for workers; image reduction, image angle change, image coloring, partial image deletion, voice/sound addition to translation, and adding production-related information and analysis result of facility 4 photographed by workers.

In this embodiment, different levels of access control for the users (workers) of working terminal 5 are set for different types of facility-related information included in the reference information, as illustrated in FIG. 8. Similar levels of per-user access control may be set as well for such information as the work procedure and/or manuals. When, for example, a non-management worker requests the working information using working terminal 5, the working information, while including the work procedure, does not necessarily include the manuals. When a chief supervisor or team leader requests the working information using working terminal 5, the working information may include both of the manuals and work procedure.

The facility-related information may not necessarily be limited to the work items, gas consumption, product properties or defect rates. The facility-related information may instead include any type(s) of information related to facility 4. For instance, the facility-related information may contain sales-related information and/or inventory-related information of products manufactured in facility 4. The facility-related information may contain information of the surrounding environment of facility 4, for example, a factory, hospital or warehouse where facility 4 is installed.

Camera 56, which is equipped in working terminal 5 in this description, may be an independent member separate from working terminal 5. Processor 51 of working terminal 5 may obtain the imaging information including the captured image of facility 4 photographed with camera 56 separately provided and transmits the obtained imaging information to server device 3.

Code 10 may not necessarily be attached directly to facility 4. Code 10 may be attached to any other suitable object apart from facility 4. Code 10 may not necessarily be a one-dimensional code like barcode or a two-dimensional code like QR code (registered trademark). Code 10 may instead be one of IC tags (integrated circuit tags), for example, passive or active tags like RFID (radio frequency identifier) or Bluetooth (registered trademark) tags. In this instance, working terminal 5 may include a reader adapted to read such IC tags.

The embodiments and examples disclosed herein are given by way of example in all aspects and should not be construed as limiting the scope of this disclosure. The scope of this disclosure is solely defined by the appended claims and is intended to cover the claims, equivalents, and all of possible modifications made without departing the scope of this disclosure.

### REFERENCE SIGNS LIST

1: information providing system, 2: network, 3: server device, 4: facility, 5: working terminal, 6: instructing terminal, 7: remote controller, 8: holder, 10: code, 31, 51, 61: processor, 32, 52, 62: communication device, 33, 53, 63: memory, 34: medium reading device, 35: recording medium, 54, 64: display, 55, 65: input interface, 56: camera, 57: microphone. 70: work position, 81: frame, 82: fixture. 109, 110, 111: indication changes, 310, 510, 610: computing unit, 320, 520, 620: communication unit, 330, 530, 630: storage, 331, 531, 631: control program. 331a: information providing program, 332: facility management table, 333: worker management table, 334: work procedure data, 335: manual data, 336: facility-related data, 337: translation data, 340: medium reader, 450, 550, 650: input unit, 540, 640: display unit, 560: image obtaining unit, 570: audio obtaining unit, 532, 632: terminal ID

1. An information providing system for use in providing information of work carried out in a facility, the information providing system comprising:
a working terminal; and
an instructing terminal that communicates with the working terminal,
the working terminal comprising:
a working communication device that outputs imaging information including an image of the facility captured with a camera; and
a working display that displays working information concerning the work carried out in the facility,
the instructing terminal comprising:
an instructing display that displays the captured image based on the imaging information;
an interface that receives instructing information serving to offer an instruction for the work carried out in the facility; and
an instructing communication device that outputs the instructing information,
the working terminal displaying, on the working display, the captured image processed based on the imaging information and the instructing information, as the working information.

2. The information providing system according to claim 1, further comprising a server device that communicates with the working terminal and the instructing terminal, the server device comprising:
a processor that generates the working information based on the imaging information and the instructing information; and
a server communication device that outputs the working information to the working terminal.

3. The information providing system according to claim 2, wherein the processor enlarges a part of the captured image included in the imaging information based on the instructing information and includes the captured image after being enlarged in the working information.

4. The information providing system according to claim 2, wherein the processor translates a text included in the instructing information and includes the translated text in the working information.

5. The information providing system according to claim 2, wherein
the server device includes a memory that stores reference information to be consulted for the work carried out in the facility, and
the processor includes, in the working information, the reference information selected based on the instructing information.

6. The information providing system according to claim 5, wherein
the working communication device outputs, to the server device, identification information used to identify a user of the working terminal, and
the processor includes, in the working information, the reference information selected based on the instructing information and the identification information.

7. The information providing system according to claim 2, wherein
the server communication device further outputs the working information to the instructing terminal, and
the instructing display displays the working information.

8. The information providing system according to claim 1, wherein
the working terminal includes the camera, and
the instructing communication device outputs, to the working terminal, remote control information for remote control of the camera.

9. A server device for use in providing information of work carried out in a facility, the server device comprising:
a server communication device that communicates with a working terminal and an instructing terminal; and
a processor,
the server communication device
obtaining, from the working terminal, imaging information including an image of the facility captured with a camera,
obtaining, from the instructing terminal, instructing information serving to offer an instruction for the work carried out in the facility,
the processor processing the captured image based on the imaging information and the instructing information to generate working information concerning the work carried out in the facility that includes the captured image that has been processed, and
the server communication device outputting the working information to the working terminal.

10. An information providing method for use in providing information of work carried out in a facility, the information providing method comprising:
obtaining, from a working terminal, imaging information including an image of the facility captured with a camera;
obtaining, from an instructing terminal, instructing information serving to offer an instruction for the work carried out in the facility;
processing the captured image based on the imaging information and the instructing information to generate working information concerning the work carried out in the facility that includes the captured image that has been processed; and
outputting the working information to the working terminal.

11. (canceled)
